(19) United States
(12) Patent Application Publication
(10) Pub. No.: US 2026/0048349 A1
(43) Pub. Date: Feb. 19, 2026

(54) METHODS AND APPARATUS FOR SPIN DOWN FILTER WITH ELECTROMAGNETIC FIELDS

(71) Applicant: Zhuangyong Chen, Alpharetta, GA (US)

(72) Inventor: Zhuangyong Chen, Alpharetta, GA (US)

(21) Appl. No.: 18/807,155

(22) Filed: Aug. 16, 2024

(51) Int. Cl. B01D 35/06; B01D 29/11; B01D 29/64; B01D 29/94

(52) U.S. Cl. CPC B01D 35/06; B01D 29/11; B01D 29/64; B01D 29/94; B01D 2201/167; B01D 2201/64

(57) ABSTRACT

A spin down filter with induced electromagnetic fields according to various aspects of the present technology is configured to provide a filtration device capable of providing a multi-layer filtration system that also softens and sanitizes a water supply. The spin down filter comprises a housing with a set of opposing magnets positioned around a spin down filter body. A collection of steel pins is distributed within a main area of the spin down filter and are responsive to magnetic fields created by the housing which cause the pins to act as a loose filter bed for trapping large particulates. A coil wrapped filter within the spin down filter body provides additional filtration. An electrical current may be passed through the coil to generate an electromagnet for removal of charged ions in the water and a pulsed electric field may be used to reduce microbial levels in the water.

### BACKGROUND OF THE INVENTION

Conventional spin down filters primarily rely on passive filtration with static meshes or cartridges to trap particulates. Often, spin down filters are used to remove larger particulates such as sand and other debris that would quickly clog filter media used in other types of filtration systems. As a result, spin down filters require increased maintenance such as manual cleaning or cartridge replacement to avoid potential clogging and diminished filtration efficiency over time. Spin down filters are also not particularly effective at addressing water hardness and sanitation and therefore may require a user to include a secondary filtration system if softened water or guaranteed sanitized water is desired.

### SUMMARY OF THE INVENTION

A spin down filter with induced electromagnetic fields according to various aspects of the present technology is configured to provide a filtration device capable of providing a multi-layer filtration system that can also soften and sanitize a water supply. In one embodiment, the spin down filter with induced electromagnetic fields comprises a housing with a set of opposing magnets positioned around a spin down filter body. A collection of steel pins is distributed within the main area of the spin down filter and are responsive to magnetic fields created by the housing which cause the pins to act as a loose filter bed for trapping large particulates. A coil wrapped filter also positioned within the spin down filter body provide additional filtration. In addition, an electrical current may be passed through the coil to generate and electromagnet to facilitate removal of charged ions in the water and a pulsed electric field may be used to reduce microbial levels in the water.

### BRIEF DESCRIPTION OF THE DRAWINGS

A more complete understanding of the present invention may be derived by referring to the detailed description and claims when considered in connection with the following illustrative figures. In the following figures, like reference numbers refer to similar elements and steps throughout the figures.

FIG. 1 representatively illustrates a spin down filter in accordance with an exemplary embodiment of the present technology;

FIG. 2A representatively illustrates the spin down filter with magnet housing in accordance with an exemplary embodiment of the present technology;

FIG. 2B representatively illustrates the spin down filter with electromagnetic induced fields in accordance with an exemplary embodiment of the present technology;

FIG. 2C representatively illustrates the spin down filter in backwash mode in accordance with an exemplary embodiment of the present technology;

FIG. 3 representatively illustrates a side view of filter housing with the filter device removed in accordance with an exemplary embodiment of the present technology;

FIG. 4 representatively illustrates a perspective view of the magnet in accordance with an exemplary embodiment of the present technology;

FIG. 5 representatively illustrates an exploded view of the filter device in accordance with an exemplary embodiment of the present technology; and

FIG. 6 representatively illustrates a detailed view of the coil of the filter device in accordance with an exemplary embodiment of the present technology.

Elements and steps in the figures are illustrated for simplicity and clarity and have not necessarily been rendered according to any particular sequence. For example, components that may be coupled together in the manner shown or in a different order are illustrated in the figures to help to improve understanding of embodiments of the present technology.

### DETAILED DESCRIPTION OF EXEMPLARY EMBODIMENTS

The present technology may be described in terms of functional block components and various processing steps. Such functional blocks may be realized by any number of components configured to perform the specified functions and achieve the various results. For example, the present technology may employ various types of buoyant materials, magnetic devices, and devices for filtering particulates from a fluid. In addition, the present technology may be practiced in conjunction with any number of processes for filtering water and the system described is merely one exemplary application for the technology. Further, the present technology may employ any number of conventional techniques for generating electromagnetic fields, pulsed electric fields, and directing a fluid flow.

Methods and apparatus for a spin down filter with electromagnetic fields according to various aspects of the present technology provide an improved spin down filter system. Various representative implementations of the present technology may be applied to any type of existing filtering system directed to filtering particulates of varying sizes from a water supply. For example, in one embodiment, the spin down filter with electromagnetic fields may be used in with a well to provide enhanced filtering and sanitizing capabilities over what may be achieved with a prior art type of spin down filter.

Referring now to FIG. 1, a spin down filter with electromagnetic fields 100 may comprise a main filter body having a filter housing 102 connected to a filter head 104 at an upper portion and a flush valve 106 connected to a lower portion of the main filter body 102. A filter device 110 may be positioned within the filter housing 102 and be surrounded by a plurality of pins 108. One or more magnetic fields 118, 120 may be created in an area immediately surrounding the filter housing 102 to act on the pins 108. A controller 116 may also be electrically coupled to the filter head 104 and flush valve 106 and be configured to generate an electrical current that passes through the filter head 104, the filter device 110, and the flush valve 106.

The filter head 104 may include an inlet for receiving an incoming water flow and an outlet for directing a filtered water flow away from the filter housing 102 for use or storage. The filter head 104 may be attached to the filter housing 102 by any suitable method such as by being screwed onto the top of the filter housing 102. In other embodiments the filter head 104 may be connected to the filter housing 102 by a mechanical fastening device, snapped into position, or rotatably locked into position on the filter housing 102.

The filter head 104 may also be configured to be electrically conductive to allow the filter head 104 to act as a conductor. For example, an electrical current may be generated by the controller 116 and directed to the filter head 104 by a first wire 114. The filter head 104 may be electrically coupled to the filter device 110 and/or the flush valve 106 to facilitate the flow of the electrical current through the filter housing 102 allowing at least a portion of the filter device 110 to act as an electromagnet.

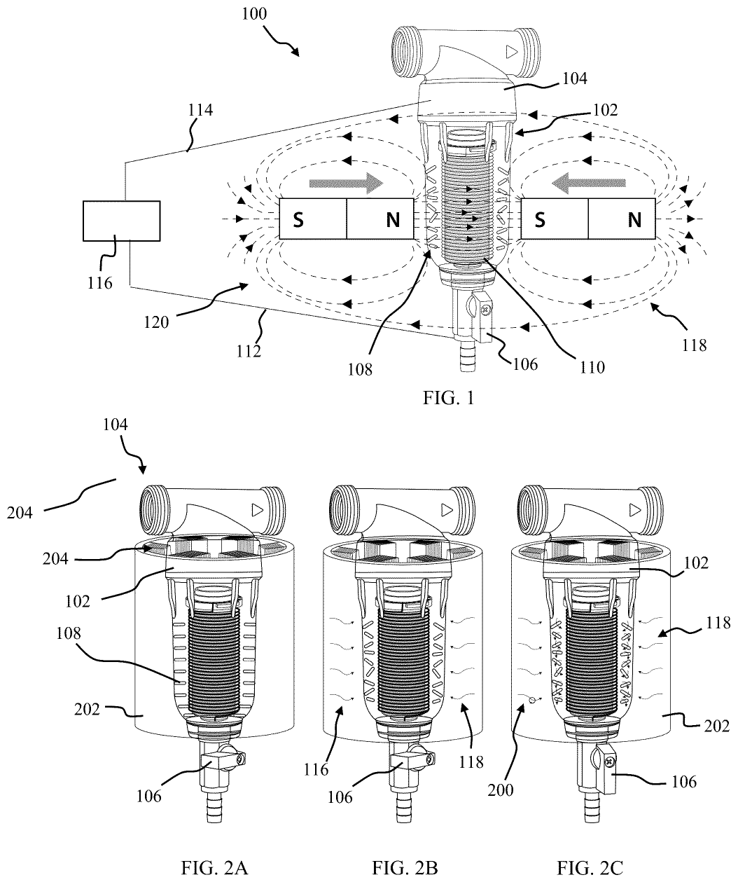

The flush valve 106 is coupled to the lower end of the filter housing 102 and is configured to allow the removal of particulates filtered from the incoming water supply to be removed from the filter housing 102. The flush valve 106 may comprise any suitable system or device such as a ball or gate valve in fluid communication with the interior volume of the filter housing 102. For example, referring now to FIGS. 2A-2C, the flush valve 106 may be configured to move between a closed state and an open state. In the open state, the flush valve 106 may allow fluid and particulates to flow out from the interior of the housing 102 to allow filtered particulates to be flushed from the spin down filter with electromagnetic fields 100.

The flush valve 106 may be operated manually or in response to a command from the controller 116. For example, a user may interact with the controller 116 to generate a flush command and then manually move the flush valve 106 into the open state (FIG. 2C). At the end of the flush cycle, the user may then manually close the flush valve 106 (FIGS. 2A and 2B). Alternatively, the controller 106 may send a flush command to the flush valve 106 causing it to automatically move from the closed state to the open state. After a period of time, another command may be sent by the controller 106 causing the flush valve 106 to move from the open state to the closed state ending the flush cycle.

The flush valve 106 may also be configured to be electrically conductive to allow the flush valve 106 to act as a second conductor. For example, the electrical current generated by the controller 116 and directed to the filter head 104 by the first wire 114. The current is then allowed to pass through the filter device 110 which is electrically coupled to the flush valve 106. The current then flows from the flush valve 106 back to the controller 116 by a second wire 112 to complete the circuit and thereby allow at least a portion of the filter device 110 to act as an electromagnet.

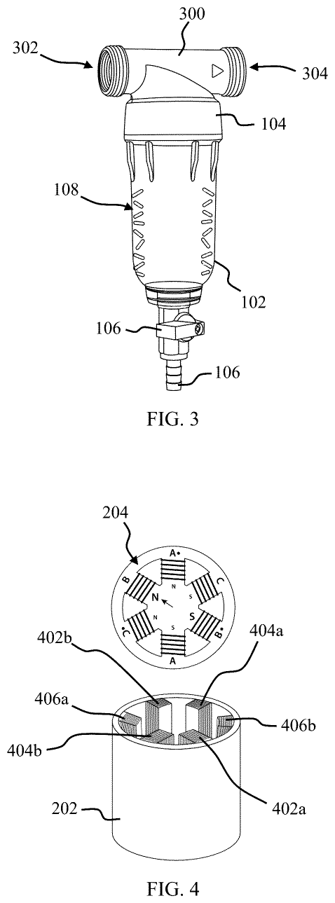

With reference now to FIGS. 1-3, a plurality of pins 108 may be located within the housing 102 and be used to provide an initial layer of filtration. The pins 108 are able to freely move about the inner volume of the housing 102 while an incoming water is flowing into the housing 102. In one embodiment, the pins 108 are formed from a metallic material that is responsive to the magnetic fields 118, 120. This allows the pins 108 to float or otherwise be allowed to freely move about the inner volume of the housing 102 by a combination of forces acting on the pins 108 such as: gravity, natural buoyancy of the pins 108, fluid flow through the housing 102, and the magnetic fields 118, 120.

During normal operation, a current passing through the filter device 110 may create an electromagnetic field which may tend to draw the pins 108 towards an outer surface of the filter device 110. The pins 108 may comprise a sufficient number to at least substantially cover the outer surface of the filter device 110 such that any water flow must pass around and through the collection of pins 108 before prior to entering the filter device 110. In this way, the pins 108 act as a loose filtration bed configured to function as a preliminary filtering stage capturing larger particulates before they can enter the filter device 110. The preliminary filtering stage may be configured to capture particulates down to about 1,000 microns (μm) in size. One of skill will appreciate that altering the size and/or shape of the pins 108 may alter the filtering capabilities of the preliminary filtering stage. For example, in one embodiment, the plurality of pins 108 may comprise the same dimensions with a diameter of between about 0.75 and 1.25 mm with a length of between about 2-10 mm. In an alternative embodiment, the plurality of pins 108 may be made up of individual pins 108 comprising various sizes.

During the flush cycle, the pins 108 may be used to clean at least a portion of the filter device 110. For example, in one embodiment, the pins 108 may be used to “scrub” or otherwise brush against each other and the outer surface of the filter device 110 to dislodge any accumulated particulates so that the particulates can be flushed from the housing 102 through the flush valve 106. (See FIG. 2C). The scrubbing action may be created by selectively altering the magnetic fields 118, 120 and/or the induced electromagnetic field.

In yet another embodiment, rather than be allowed to move freely within the housing 102, one end of each pin 108 may be coupled to an outer surface of the filter device 110 such that the second end of each pin 108 is positioned outward from the surface of the filter device 110 similar to bristles on a brush. The manner in which the pins 108 are coupled to the filter device 110 may allow the second end of each pin to move slightly in response to water flow or the existing or induced magnetic fields. The movement of the second end of the pins 108 may also be controllable to help dislodge any collected particulates from the pins 108 and/or outer surface of the filter device 110 during the flush cycle.

Referring now to FIG. 5, the filter device 110 is configured to provide enhanced filtering capabilities beyond that of the preliminary filtering stage of the pins 108. For example, in one embodiment, the filter device 110 may comprise a main body 502, a mesh screen 504 extending along a length of the main body 502, and a coil 506 wrapped around the mesh screen 504. Each end of the coil 506 may be electrically coupled to the main body 502 to allow an electrical current to pass through the filter device 110.

The coil 506 is configured to provide a finer level of filtering as compared to the pins 108 and is used to generate an electromagnetic field in response to a current flowing through the filter device 110. The coil 506 may be configured to provide a filtering level of between about 200 μm and 1,000 μm. The coil 506 may comprise any suitable material that is capable of maintaining its shape in response to a passing water flow and particulate matter while also allowing an electrical current to flow from one end of the main body 502 to the opposite end of the main body 502. The coil 506 may comprise a bare wire or it may be encased within an insulating shield to protect the coil 506 from direct contact with the water. The coil 506 may also comprise any suitable diameter and may be selected according to any suitable criteria such as a desired voltage or amperage. For example, in a relatively low voltage embodiment, the coil may comprise a wire having an outer diameter of between about 0.7 mm and 1.5 mm.

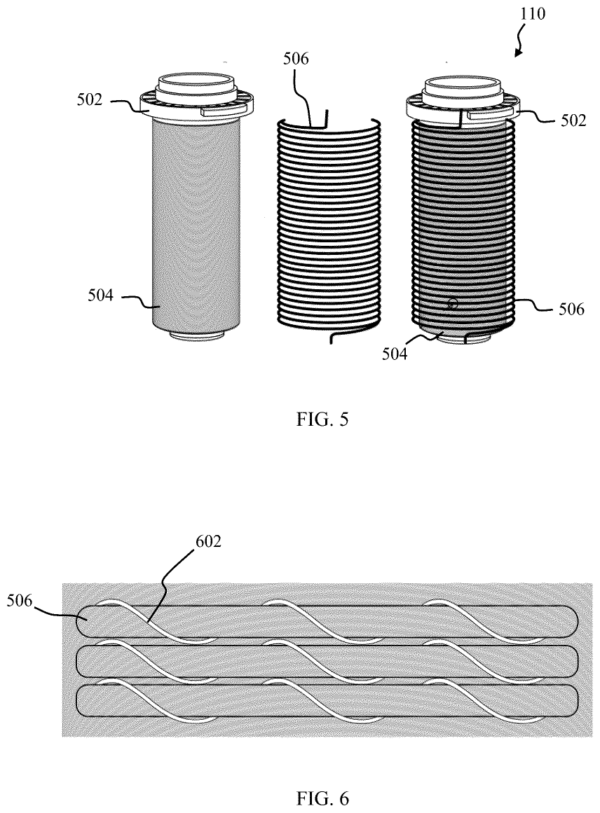

In one embodiment, and referring now to FIG. 6, individual windings of the coil 506 may be spaced apart from each other by a specified distance to facilitate the filtering of particulates from a water flow passing through the coil 506 before passing through the mesh screen 504. A spacer 602 wrapped wound around the coil 506 may be used to set the distance between each successive winding. For example, the spacer 602 may comprise an insulating string having a diameter of between about 0.07 mm and about 0.13 mm. The diameter of the spacer 602 may determine the gap between each successive winding and the filtering capability of the coil 506. The spacer 602 may also be used to maintain a gap between the coil 506 and the mesh screen 504 to ensure that as much of the surface area of the mesh screen 504 as possible is available to filter the water.

The mesh screen 504 provides a final stage of filtration and may comprise any suitable material or device for filtering the water flow. In one representative embodiment, the mesh screen 504 comprises a metallic material that is capable of providing filtering in a range of about 50 μm to about 500 μm. The metallic nature of the mesh screen 504 may help facilitate the flow of electricity from the filter head 104 through the filter device 110 and to the flush valve 106.

Referring again to FIGS. 2A-2C, the magnetic fields 118, 120 may be created by a magnet housing 202 having a plurality of magnets 204 that is positioned around or otherwise encircles the entire filter housing 102. Depending on a mode of operation, the magnetic fields 118, 120 may act on the pins 108 in a variety of ways to perform a desired function. For example, and with particular reference to FIG. 2A, in a general state, the magnetic fields 118, 120 help maintain the position of the pins 108 within the filter housing 102 by helping to counteract forces such gravity that would tend to cause the pins 108 to settle at the bottom of the filter housing 102.

Referring now to FIG. 4, a series of magnet pairs 402a-b, 404a-b, 406a-b may be positioned within the magnet housing 202 between an inner wall of the magnet housing 202 and the filter housing 102. Each magnet pair generates an external magnetic field relative to the filter housing 102. One of skill will appreciate that increasing or decreasing the number of magnet pairs located within the magnet housing 202 may increase or decrease the overall strength of the magnetic fields 118, 120 encircling the filter housing 102 that can interact with the pins 108.

The magnet pairs may comprise any suitable object or device that is magnetized. In addition, the magnet pairs may be formed of any suitably selected types of magnets to provide a desired magnetic field. For example, in an embodiment where a stronger magnetic field is desired, rare earth magnets may be used to form each magnet pair. In other embodiments, the magnet pairs may be formed with ferrite or alnico magnets.

The magnet pairs may be arranged in the magnet housing 202 to orient the magnet fields 118, 120 in a desired direction. For example, in one embodiment, individual magnets 402a, 404a, and 406a may be arranged to generally align a north pole on a first side of the magnetic housing 202 and the opposing magnets 402b, 404b, 406b may be arranged to locate the south pole on the opposite side of the magnetic housing 202. In an alternative embodiment, the individual magnets may be arranged in a different orientation to accomplish a different desired results such as to create more distinct magnetic fields or to increase or decrease the strength of the magnetic fields surrounding the filter housing 102.

The controller 116 may be configured to initiate and control an electrical current that is passed through the filter head 104, the filter housing 102, and the flush valve 106. The controller 116 may comprise any suitable system or device for controlling the function and operation of the spin down filter 100 and electromagnetic fields. In one embodiment, the controller 116 may be configured to provide a low-voltage DC current that is used to generate the electromagnetic field created by the filter device 110 during normal operation. The controller 116 may also be communicatively linked to one or more sensors such as flow sensor, pressure sensor, and conductivity sensor located in the filter head 104 or the filter housing 102. The sensors may be configured to monitor various parameters in real-time and can generate one or more signals designed to trigger the controller to activate other operational modes (e.g., flush mode when clogging is detected) to help maintain an optimal filtration performance and system responsiveness to ongoing conditions.

During operation, the controller 116 may also be configured to apply a pulsed electric field (PEF) to the coil 506 and/or the mesh screen 504 to disrupt the cellular structure of microorganisms that may be present in the water and thereby provide increased sanitation of the filtered water. PEF may also help facilitate hardness reduction of the water by precipitating hardness ions onto the pins 108, the coil 506, and the mesh screen 504 for subsequent removal during the flushing cycle.

In flush mode, the controller 116 may be configured to alternate the generated electromagnetic field to cause the filter device 110 to vibrate, shake or otherwise oscillate to disrupt the pins 108 such that they move and come into repeated contact with each other and the coil 506. This repeated contact helps to dislodge and trapped particulates when may then fall downward in the filter device 110 towards the flush valve 106. Similarly, vibrations between the coil 506 and the mesh screen 504 may help scrub particulates from the mesh screen 504 which may then be flushed from the filter housing 102.

The controller 116 may be configured or programmed to activate the flush mode on a regular cycle or in response to signals from the one or more sensors. The controller 116 may also be configured to transmit a signal to another remote system or application to provide a user with an operation status of the spin down filter 100.

The technology has been described with reference to specific exemplary embodiments. Various modifications and changes, however, may be made without departing from the scope of the present technology. The description and figures are to be regarded in an illustrative manner, rather than a restrictive one and all such modifications are intended to be included within the scope of the present technology. Accordingly, the scope of the technology should be determined by the generic embodiments described and their legal equivalents rather than by merely the specific examples described above. For example, the steps recited in any method or process embodiment may be executed in any order, unless otherwise expressly specified, and are not limited to the explicit order presented in the specific examples. Additionally, the components and/or elements recited in any apparatus embodiment may be assembled or otherwise operationally configured in a variety of permutations to produce substantially the same result as the present invention and are accordingly not limited to the specific configuration recited in the specific examples.

Benefits, other advantages and solutions to problems have been described above with regard to particular embodiments; however, any benefit, advantage, solution to problems or any element that may cause any particular benefit, advantage or solution to occur or to become more pronounced are not to be construed as critical, required or essential features or components.

As used herein, the terms “comprises,” “comprising,” or any variation thereof, are intended to reference a non-exclusive inclusion, such that a process, method, article, composition or apparatus that comprises a list of elements does not include only those elements recited but may also include other elements not expressly listed or inherent to such process, method, article, composition or apparatus. Other combinations and/or modifications of the above-described structures, arrangements, applications, proportions, elements, materials or components used in the practice of the present technology, in addition to those not specifically recited, may be varied or otherwise particularly adapted to specific environments, manufacturing specifications, design parameters or other operating requirements without departing from the general principles of the same. Any terms of degree such as “substantially,” “about,” and “approximate” as used herein mean a reasonable amount of deviation of the modified term such that the end result is not significantly changed. For example, these terms can be construed as including a deviation of at least ±5% of the modified term if this deviation would not negate the meaning of the word it modifies.

The present technology has been described above with reference to a preferred embodiment. However, changes and modifications may be made to the preferred embodiment without departing from the scope of the present invention. These and other changes or modifications are intended to be included within the scope of the present technology, as expressed in the following claims.

1. A spin down filter, comprising:
a main filter body, comprising:
a filter housing;
a filter head coupled to an upper portion of the filter housing and configured to act as a first electrode;
a filter device disposed within the filter housing and electrically coupled to the filter head; and
a plurality of pins disposed between the filter device and an inner surface of the filter housing;
a magnet housing surrounding the main filter body;
a flush valve connected to a lower portion of the filter housing, electrically coupled to the filter device, and configured to act as a second electrode; and
a controller electrically coupled to the filter head and the flush valve and configured to pass an electrical current through the filter head, the filter device, and the flush valve.

2. A spin down filter according to claim 1, wherein the filter device comprises:
a cartridge body; and
a coil encircling the electrically the cartridge body and coupled to the filter device and the flush valve.

3. A spin down filter according to claim 2, wherein the cartridge body comprises a steel mesh electrically coupled to the filter head and the flush valve.

4. A spin down filter according to claim 2, wherein the coil comprises an insulating spacer positioned between each winding.

5. A spin down filter according to claim 1, wherein the magnet housing comprises:
a substantially tubular sidewall; and
a set of paired magnets positioned around an inner surface of the housing sidewall.

6. A spin down filter according to claim 1, wherein the controller is configured to:
pass a low voltage DC current through the filter head, the filter device, and the flush valve; and
generate a pulsed electric field through the filter head, the filter device, and the flush valve.

7. A spin down filter according to claim 1, wherein the controller is configured to alternate a direction of a low voltage DC current through the filter head, the filter device, and the flush valve to vibrate the coil in response to a command to enter a flush mode.

8. A spin down filter according to claim 7, wherein the controller is further configured to open the flush valve.

9. A spin down filter according to claim 1, wherein the plurality of pins are free floating within the filter housing.

10. A spin down filter system, comprising:
a main filter body, comprising:
a filter housing having an internal volume configured to cause an inflow of water to rotate within the filter housing;
a filter head detachably coupled to an upper end of the filter housing and configured to act as a first electrode;
a multi-stage filter device disposed within a center portion of the filter housing and electrically coupled to the filter head, wherein the multi-stage filter comprises:
a cartridge body; and
a coil encircling the electrically the cartridge body and electrically coupled to the filter head; and
a plurality of metallic pins disposed between the multi-stage filter device and an inner surface of the filter housing, wherein the plurality of metallic pins form a loose filter bed in front of the multi-stage filter device in response to an electrical current being passed through the coil;
a magnet housing surrounding the main filter body;
a flush valve connected to a lower end of the filter housing, electrically coupled to the coil, and configured to act as a second electrode; and
a controller electrically coupled to the filter head and the flush valve and configured to pass an electrical current through the filter head, the multi-stage filter device, and the flush valve.

11. A spin down filter system according to claim 10, wherein the cartridge body comprises a steel mesh electrically coupled to the coil, the filter head, and the flush valve.

12. A spin down filter system according to claim 10, wherein the coil comprises an insulating spacer positioned between each winding.

13. A spin down filter system according to claim 10, wherein the magnet housing comprises:
a substantially tubular sidewall; and
a set of paired magnets positioned around an inner surface of the housing sidewall.

14. A spin down filter system according to claim 10, wherein the controller is configured to:
pass a low voltage DC current through the filter head, the multi-stage filter device, and the flush valve; and
generate a pulsed electric field through the filter head, the multi-stage filter device, and the flush valve.

15. A spin down filter system according to claim 10, wherein the controller is configured to alternate a direction of a low voltage DC current through the filter head, the multi-stage filter device, and the flush valve to vibrate the coil in response to a command to enter a flush mode.

16. A spin down filter system according to claim 15, wherein the controller is further configured to open the flush valve.

17. A spin down filter system according to claim 10, wherein the plurality of pins are free floating within the filter housing.
